(19) United States
(12) Patent Application Publication
(10) Pub. No.: US 2023/0237900 A1
(43) Pub. Date: Jul. 27, 2023

(54) DEPLOYMENT OF ROAD BARRIERS FOR RESERVED CORRIDORS

(71) Applicant: Cavnue Technology, LLC, Arlington, VA (US)

(72) Inventor: DEMETRIOS VASILI KELLARI, Brooklyn, NY (US)

(21) Appl. No.: 18/160,743

(22) Filed: Jan. 27, 2023

Related U.S. Application Data
(60) Provisional application No. 63/303,705, filed on Jan. 27, 2022.
(60) Provisional application No. 63/304,141, filed on Jan. 28, 2022.

(51) Int. Cl. G08G 1/01; E01F 13/00; G08G 1/0967

(52) U.S. Cl. CPC G08G 1/0137; E01F 13/00; G08G 1/0116; G08G 1/096708

(57) ABSTRACT

Methods, systems, and computer-readable storage media for obtaining sensor data captured by one or more sensors that generate data representative of characteristics of a roadway, determining a state of the roadway by processing the sensor data, the state at least partially comprising a first configuration of the roadway, determining, at least partially based on the state, a period of time to deploy a plurality of road barriers on the roadway, and deploying the plurality of road barriers based on the period of time to provide a second configuration comprising at least one dedicated lane.

### CROSS-REFERENCE TO RELATED APPLICATION

This application claims priority to and the benefit of U.S. Prov. App. No. 63/303,705, filed on Jan. 27, 2022 and U.S. Prov. App. No. 63/304,141, filed Jan. 28, 2022, which are expressly incorporated herein by reference in the entirety for all purposes.

### BACKGROUND

Vehicles can travel on roadways, highways, and backroads to their destination. In many cases, a vehicle can travel along a road with other vehicles and is positioned behind the other vehicles, next to another vehicle, or in front of another vehicle during its journey. Additionally, vehicles often move positions on the roadway by accelerating, decelerating, or changing lanes. Given the number of vehicles in any given section of road, and the changing speed and positions of the vehicles, collecting and maintaining vehicle speed and position data, and other vehicle data, is a complex and processing intensive task.

### SUMMARY

Implementations of the present disclosure are directed to a barrier deployment system for roadways. More particularly, implementations of the present disclosure are directed to a barrier deployment system to provide reserved corridors.

In some implementations, actions include obtaining sensor data captured by one or more sensors that generate data representative of characteristics of a roadway, determining a state of the roadway by processing the sensor data, the state at least partially comprising a first configuration of the roadway, determining, at least partially based on the state, a period of time to deploy a plurality of road barriers on the roadway, and deploying the plurality of road barriers based on the period of time to provide a second configuration comprising at least one dedicated lane. Other implementations of this aspect include corresponding systems, apparatus, and computer programs, configured to perform the actions of the methods, encoded on computer storage devices.

These and other implementations can each optionally include one or more of the following features: determining, at least partially based on the state, the period of time to deploy the plurality of road barriers on the roadway includes determining the period of time to deploy the plurality of road barriers on the roadway using a predetermined rule; determining, at least partially based on the road state, the period of time to deploy the plurality of road barriers on the roadway includes predicting the period of time to deploy the plurality of road barriers on the roadway using a machine learning model; the state is at least partially generated from the sensor data captured by the one or more sensors at a first time point, and determining the period of time to deploy the plurality of road barriers on the roadway includes determining, based on the state at the first time point, a second time point to deploy the plurality of road barriers, wherein the second time point is at a later time point than the first time point; deploying the plurality of road barriers is performed by a vehicle that travels on the roadway, and operations further include sending a signal to the vehicle, wherein the signal is based on the period of time to deploy the plurality of road barriers on the roadway, and deploying, by the vehicle, the plurality of road barriers on the roadway at a time that is based on at least the signal; determining, at least partially based on the state, the period of time to deploy the plurality of road barriers on the roadway includes maximizing a period of time that the roadway has the at least one dedicated lane; the at least one dedicated lane is for one or more autonomous vehicles and semi-autonomous vehicles; the first roadway configuration is absent any dedicated lanes; the plurality of road barriers includes virtual barriers and deploying the plurality of road barriers at least partially includes sending data indicating the virtual barriers to vehicles on the roadway for period of time, wherein after receiving the data indicating the virtual barriers, the vehicles are instructed to not cross the virtual barriers; actions further include determining, based on the state, a period of time to remove the plurality of road barriers on the roadway, and removing the plurality of road barriers for the period of time to provide a third roadway configuration; the second configuration includes the at least one dedicated lane having a first length and the third configuration includes the at least one dedicated lane having a second length that is different from the first length; and the second configuration includes the at least one dedicated lane having a first location and the third configuration includes the at least one dedicated lane having a second location that is different from the first location.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIGS. 1A-1C depict an example progression of deploying barriers in accordance with implementations of the present disclosure.

FIG. 2 depicts an example deployment of virtual barriers in accordance with implementations of the present disclosure.

FIG. 3 depicts an example process that can be executed in accordance with implementations of the present disclosure.

Like reference symbols in the various drawings indicate like elements.

### DETAILED DESCRIPTION

Implementations of the present disclosure are directed to a barrier deployment system for roadways. More particularly, implementations of the present disclosure are directed to a barrier deployment system to provide reserved corridors. In some examples, a reserved corridor can include a dedicated lane for one or more types of vehicles (e.g., autonomous vehicles, semi-autonomous vehicles). As described herein, the barrier deployment system of the present disclosure enables selective provisioning of reserved corridors to improve traffic flow, safety, and efficiency outcomes. These reserved corridors can come in many different forms and the barrier deployment system is used to predict which configuration would be optimal, when to safely deploy the configuration, and execute deployment.

Implementations can include actions of obtaining sensor data captured by one or more sensors that generate data representative of characteristics of a roadway, determining a state of the roadway by processing the sensor data, the state at least partially comprising a first configuration of the roadway, determining, at least partially based on the state, a period of time to deploy a plurality of road barriers on the roadway, and deploying the plurality of road barriers based on the period of time to provide a second configuration comprising at least one dedicated lane.

To provide further context for implementations of the present disclosure, and as introduced above, vehicles can travel on surface streets, highways, backroads, and the like (collectively referred to herein as roads or roadways) to their destination. In many cases, a vehicle can travel along a roadway with other vehicles and is positioned behind the other vehicles, next to another vehicle, or in front of another vehicle during its journey. Additionally, vehicles often move positions on the roadway by accelerating, decelerating, or changing lanes. Given the number of vehicles in any given section of road, and the changing speed and positions of the vehicles, collecting and maintaining vehicle speed and position data, and other vehicle data, is a complex and processing intensive task.

In some instances, roadways can include designated lanes that can include, for example and without limitation, general-purpose lanes and dedicated lanes. A general-purpose lane can correspond to a lane that is driven on by the public without any restrictions to the type of vehicle and/or tolls to be applied for use of the lanes. For example, the general-purpose lane can include a lane that a driver can drive freely towards their destination. A dedicated lane, which can also be referred to as a reserved corridor, can be a lane that enables vehicles with special access following meeting conditions or criteria. For example, a dedicated lane can be provided for autonomous and/or semi-autonomous vehicles to the exclusion of other types of vehicles, such as human-operated (manual) vehicles. Barriers can be implemented along the roadway to delineate between types of lanes.

A roadway configuration can be provided that defines types of lanes across the roadway. For example, a roadway configuration can define one or more lanes as general-purpose lanes and one or more lanes as dedicated lanes. A roadway configuration, however, can change over time. For example, for a first period of time a first roadway configuration can be provided that includes one or more general-purpose lanes and one or more dedicated lanes and, for a second period of time, a second roadway configuration can be provided that only includes general-purpose lanes and is absent any dedicated lanes. In view of this, barriers need to be deployed and/or reconfigured with the changing roadway configurations. However, considerations of timing of changes in configuration must take into account traffic flow, safety, and the like.

In view of the above context, implementations of the present disclosure are directed to a barrier deployment system to selectively provide reserved corridors, such as dedicated lanes, for different types of vehicles along roadways. As described in further detail herein, the barrier deployment system of the present disclosure can be responsive changes in roadway configurations and enable deployment and reconfiguration of barriers to enable dynamic roadway configurations. In some examples, the barrier deployment system includes sensors that provide data representative of one or more states of the roadway. Other data can include, without limitation, historical data, vehicular data, and other roadway configuration data. The data can be processed to determined roadway configurations and implement deployment/reconfiguration of barriers. For example, each roadway configuration can specify a geometry of lanes and lane types that enable vehicles to be aware of and divert to/from a general-purpose lane to a dedicated lane. In some examples, the geometry can include a general-purpose lane, an opening lane, a transition lane, and a dedicated lane. The geometry can further provide characteristics of the roadway configuration that can include, for example and without limitation, a length of a lane, a width of a lane, a number of lanes, a number of turns for each lane, and an angle of the turns for each lane.

In some implementations, a roadway configuration can include a set of parameters. Example parameters can include, without limitation, a number of general-purpose lanes, a number of dedicated lanes, a location of each lane, a length of each lane, and the like. In some examples, a change in roadway configuration can include a change to one or more parameters in the set of parameters. For example, a change can include types of lanes (e.g., change from only general-purpose lanes to one or more general-purpose lanes and one or more dedicated lanes). As another example, a change can include location of lanes (e.g., a dedicated lane that runs from mile marker X to mile marker Y is changed to run from mile marker X+Z to mile marker Y+Z). As another example, a change can include length of lanes (e.g., a dedicated lane that runs from mile marker X to mile marker Y is changed to run from mile marker X to mile marker Y+Z).

The barrier deployment system of the present disclosure can be realized using electronic equipment located along roadways. For example, the barrier deployment system of the present disclosure can be implemented in systems, such as those disclosed in commonly assigned U.S. App. No. 17/210,099, filed on Mar. 23, 2021, and entitled Road Element Sensors and Identifiers, commonly assigned U.S. App. No. 17/476,800, filed on Sep. 16, 2021, and entitled Intelligent Entry and Egress for Dedicated Lane, commonly assigned U.S. App. No. 18/157,867, filed on Jan. 23, 2023, and entitled Intelligent Road Barrier System, and commonly assigned U.S. App. No. 18/159,771, filed on Jan. 24, 2023, and entitled Virtual Barriers for Reserved Corridors, each of which is expressly incorporated herein by reference in the entirety for all purposes.

Implementations of the present disclosure can be realized using an intelligent road barrier (IRB) system, such as that disclosed in commonly assigned U.S. App. No. 18/157,867, introduced above. While the IRB system is referenced herein for purposes of non-limiting illustration, implementations of the present disclosure can be realized using any appropriate system.

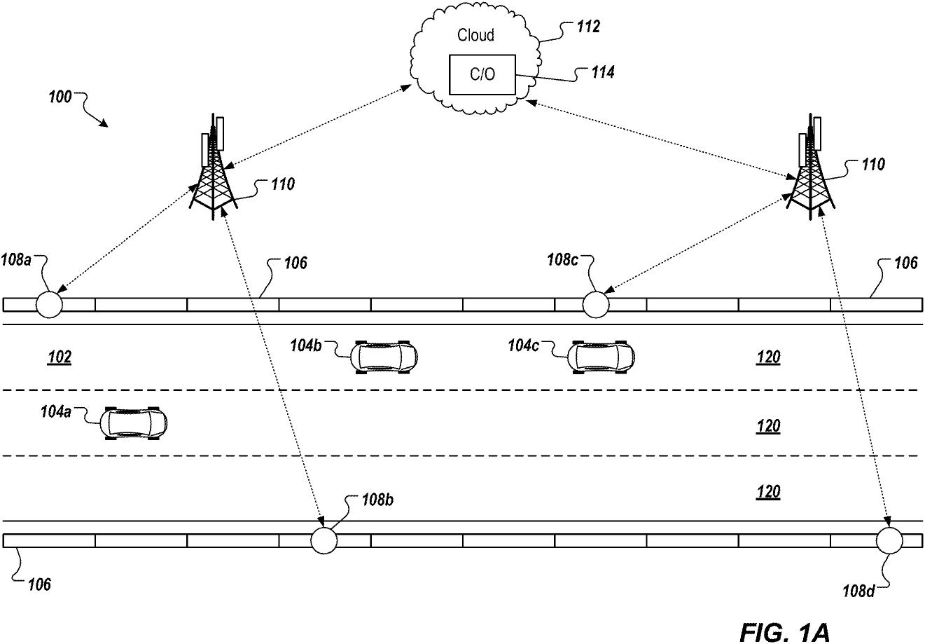

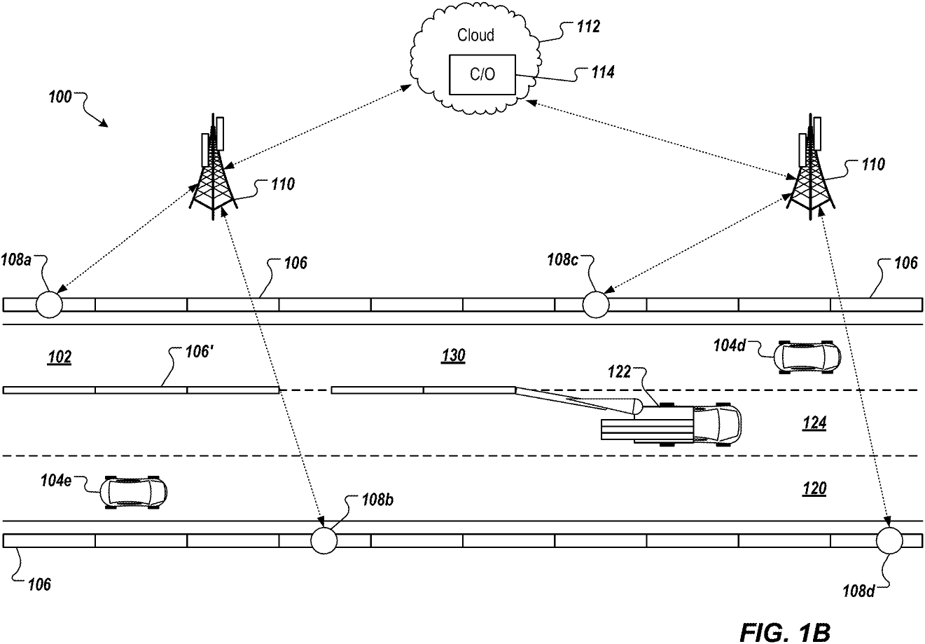

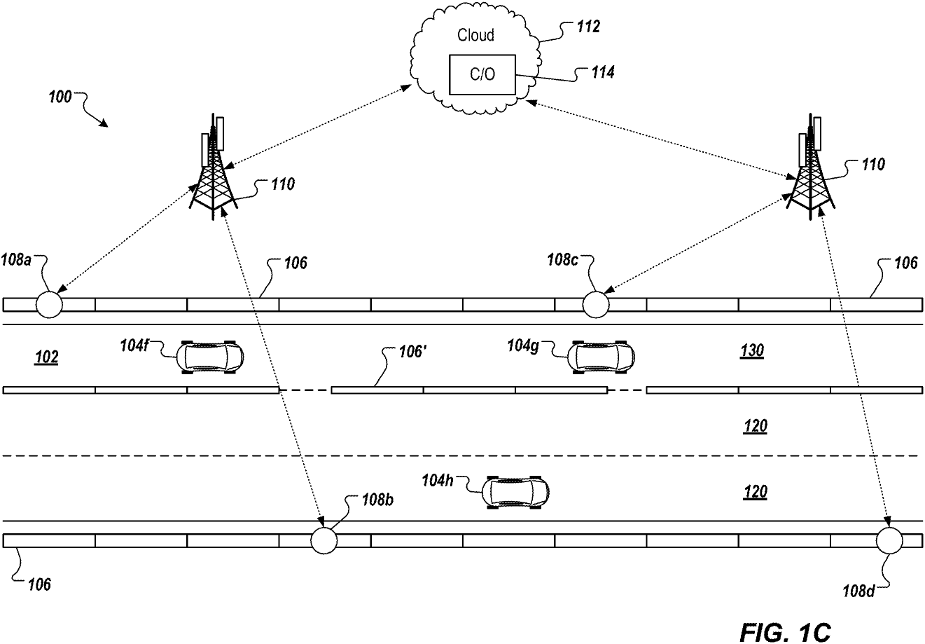

FIGS. 1A-1C depict an example architecture that can be used to execute implementations of the present disclosure. More particularly, FIGS. 1A-1C depict an example progression of deployment of physical barriers.

FIG. 1A depicts an example architecture that includes an IRB system 100 in accordance with implementations of the present disclosure. The example architecture includes a roadway 102, along which vehicles 104a, 104b, 104c travel. In the example of FIG. 1A, the IRB system 100 includes road barriers 106, and IRB kits 108a, 108b, 108c, 108d, each of which is mounted to or integrated with a respective road barrier 106. In some examples, one or more telecommunications towers 110 (e.g., representing at least a portion of a cellular network) enable communication with a cloud-based system 112. In the example of FIG. 1A, the cloud-based system 112 hosts a control and orchestration (C/O) system 114.

In some examples, the road barriers 106 can be any appropriate type of road barriers, such as, for example and without limitation, continuous (e.g., jersey barriers) or discrete barriers (e.g., delineator posts or bollards). In some examples, the road barriers 106 can be made of concrete, metal, plastic, and/or any other appropriate material. The road barriers can be placed on the roadway 102, which generally functions as a general-purpose roadway, such that a section of the roadway (e.g., a lane of the road) can operate as an intelligent section that provides advanced road operations enabled by the IRB system 100. For example, and as described in further detail herein, the intelligent section can include dynamic roadway configurations that can be adjusted using the barrier deployment system of the present disclosure.

As depicted in FIG. 1A, each IRB kit 108a, 108b, 108c, 108d is attached to or integrated with a respective road barrier 106 located along a roadway. As described in further detail herein, each IRB kit 108a, 108b, 108c, 108d is operable to collect data representative of one or more characteristics associated with the roadway 102 (e.g., agent characteristics, infrastructure characteristics, environment characteristics), processing of data, communication of data (e.g., to one or more agents, to one or more other IRB kits, to the C/O system 114), and communication of road state information (e.g., to one or more agents, to one or more other IRB kits, to the C/O system 114).

In some implementations, each IRB kit 108a, 108b, 108c, 108d can send data generated by one or more sensors to the C/O system 114. The C/O system 114 can process and analyze the data, determine a road state of the roadway 102 based on the data, and send road state information to one or more of the IRB kits 108a, 108b, 108c, 108d of the IRB system 100 and/or one or more of the vehicles 104a, 104b, 104c. For example, in system-level optimization use cases, the IRB system 100 can aggregate sensor data from multiple sensors and send the aggregated sensor data to the C/O system 114. The C/O system 114 can synchronize and coordinate between the sensor data collected by different sensors at the system level. For example, the C/O system 114 can be configured to process the sensor data obtained by the sensors of different IRB kit 108a, 108b, 108c, 108d and to coordinate temporal-spatial information of the sensor data.

Generally, the vehicles 104a, 104b, 104c can move along or traverse the roadway 102 in accordance with a current roadway configuration. For example, in the example of FIG. 1A, the roadway can include only general-purpose lanes 120. In this example, the vehicles 104a, 104b, 104c can travel along any lane, subject to traffic laws (e.g., slower vehicles on right, only pass on left).

In some implementations, the C/O system 114 can determine the roadway configuration that is to be implemented. For example, in a first period of time represented in FIG. 1A, the C/O system 114 can determine a first configuration that includes only the general-purpose lanes 120. In some examples, the C/O system 114 can assess road state to selectively change the roadway configuration for a second period of time by, for example, modifying lane designations of the roadway 102 to generate a roadway configuration that includes one or more dedicated lanes and enables access and egress to the dedicated lanes. In some examples, the C/O system 114 can generate a new roadway configuration for enabling access and egress to dedicated lanes. In some examples, the C/O system 114 can change designation of a lane from general-purpose to dedicated or from dedicated to general-purpose in response to road state information.

In further detail, the C/O system 114 can generate roadway configurations that include various lane designations and characteristics. The various lane designations can include general-purpose lanes, opening lanes, transition lanes, and dedicated lanes. In some examples, the number of each designated lane for the roadway configuration may vary depending on the number of lanes available on the roadway 102. For example, the number of lanes along a section of the roadway 102 can range from 1 to n, where n is an integer that is greater than 1. In some examples, a minimum number of general-purpose lanes can be required. For example, if a section of the roadway 102 includes two lanes and the minimum number of general-purpose lanes is two, no lane can be designated as a dedicated lane for the section. As another example, if a section of the roadway 102 includes three lanes and the minimum number of general-purpose lanes is two, one lane can be designated as a dedicated lane for the section.

In some examples, the C/O system 114 can determine a number of characteristics associated with each lane of the roadway 102. Example characteristics can include, without limitation, a length of a lane, a width of a lane, a number of turns for each lane, and an angle of the turns for each lane. The C/O system 114 can configure these lanes using the various characteristics. The C/O system 114 can generate the roadway configuration with the various characteristics based on obtained sensor data, historical data, vehicular data, and other roadway configuration data.

In some examples, for the C/O system 114 to generate roadway configurations, the C/O system 114 can analyze road state information, which, among other features, can represent the positions, movements, and other characteristics of vehicles and/or other agents along one or more prior configured roadways. For example, the C/O system 114 can analyze characteristics of vehicles driving on the prior roadways to determine a specific geometric roadway configuration that enables vehicles to access and egress dedicated lanes. In some examples, the IRB system 100 can generate and monitor sensor data over time to describe characteristics of the agents (road actors) along certain points of the prior configured roadways. For example, the C/O system 114 can acquire from prior roadways configured with sensors: (i) observations of prevailing speeds of vehicles in general purpose lanes; (ii) observations of historic speeds of vehicles along a roadway; (iii) observations of vehicle dynamics; and, (iv) observations of sensor fields of view to ensure vehicles are properly seen at each portion along the configured roadway. The C/O system 114 can obtain sensor data from sensors monitoring the one or more prior configured roadways. Based on the sensor data, the C/O system 114 can generate a specific geometric configuration of a new roadway that enables vehicles in traffic to divert from the general-purpose lane to access and egress one or more dedicated lanes.

In some examples, after the C/O system 114 has determined a roadway configuration that is to be implemented, the barrier deployment system of the present disclosure (which can include the C/O system 114) deploys and/or reconfigures barriers to provide the roadway configuration. For example, the barrier deployment system can deploy physical barriers and/or virtual barriers, as described in further detail herein.

For example, FIGS. 1B and 1C depict example deployment of physical barriers 106′. In some examples, the barriers 106′ can be made of concrete, metal, plastic, and/or any other appropriate material. With particular reference to FIG. 1B, a deployment vehicle 122 is depicted that deploys the barriers 106′. In some examples, during deployment, a lane that the deployment vehicle 122 travels in is designated as an occupied lane 124 and a general-purpose lane 120 is maintained for travel of vehicles, such as vehicle 104e. In the example of FIG. 1B, the barriers 106′ are deployed to define a dedicated lane 130. With particular reference to FIG. 1C, after deployment, the roadway 102 is configured to include the dedicated lane 130 and two general-purpose lanes 120. In the example of FIG. 1C, vehicles 104f, 104g travel along the dedicated lane 130, while a vehicle 104h travels along a general-purpose lane 120. For example, the vehicles 104f, 104g can each be of a type of vehicle that is allowed access to the dedicated lane (e.g., autonomous, semi-autonomous vehicle), while the vehicle 104h is not of a type of vehicle that is allowed to access the dedicated lane (e.g., human-operated vehicle).

In some examples, the C/O system 114 can determine that the roadway configuration is to change to only include general-purpose lanes 120. In response, the barrier deployment system can operate to remove and/or reconfigure the barriers 106′ (e.g., the deployment vehicle 122 removes the barriers 106′).

As noted above, FIGS. 1B and 1C represent deployment of physical barriers 106′ using a deployment vehicle 122. It is contemplated, however, that implementations of the present disclosure can use any appropriate means for deployment of physical barriers. For example, and without limitation, the roadway 102 can be configured to include retractable barriers that can be selectively raised up from the roadway 102 to define a dedicated lane 130 and retracted into the roadway 102 to eliminate the dedicated lane 130.

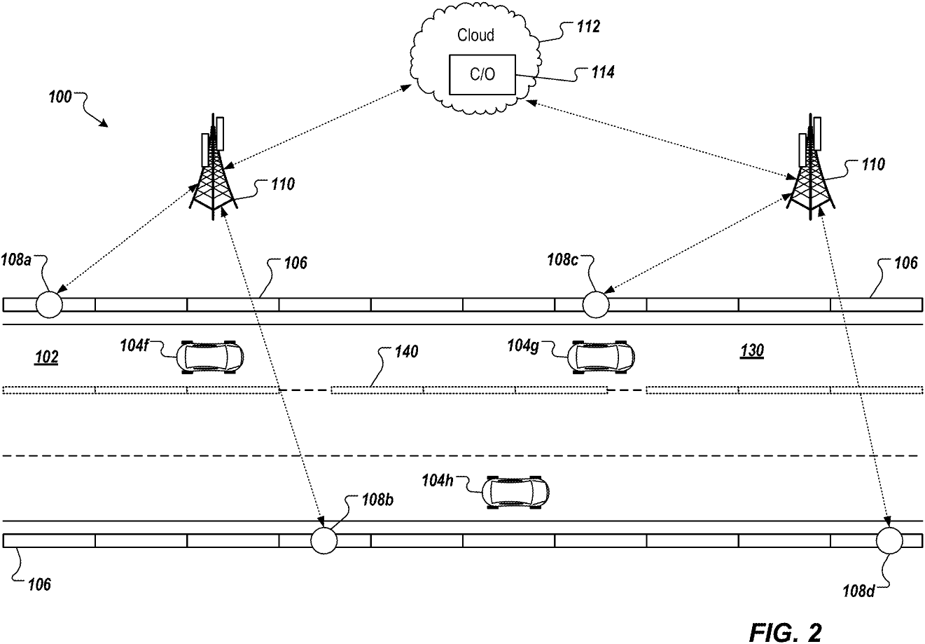

With particular reference to FIG. 2, and as noted above, the barrier deployment system of the present disclosure can include deployment of virtual barriers 140, which are described in further detail in U.S. App. No. [Attorney Docket No. 51618-0012001]. For example, deployment of the virtual barriers 140 can include defining the virtual barriers 140 in a data space representative of the roadway 102, which is communicated to vehicles, such as the vehicles 104f, 104g. The vehicles can process the data space to be aware of the presence and location of the virtual barriers 140 and operated accordingly. In some implementations, roadway configurations can be defined using both physical barriers 106′ and virtual barriers 140.

In further detail, the barrier deployment system can deploy the virtual barriers by sending data indicating the virtual barriers to vehicles on the roadway (e.g., autonomous vehicles, semi-autonomous vehicles, traditional vehicles). That is, the barrier deployment system can create the reserved corridor by sending data indicating the virtual barriers to vehicles on the roadway. After receiving data indicating the virtual barriers, vehicles on the roadway do not cross the virtual barriers as if the virtual barriers are physical road barriers. For example, an autonomous vehicle can save the data indicating the virtual barriers in the perception system of the autonomous vehicle. The autonomous vehicle can perceive the virtual barriers as virtual objects that the autonomous vehicle is not allowed to cross.

As described herein, the barrier deployment system of the present disclosure enables the dynamic generations of roadway configurations to selectively include reserved corridors, such as dedicated lanes. In some examples, the dedicated lanes are dedicated for particular types of vehicles, such as autonomous vehicles and/or semi-autonomous vehicles. As described herein with reference to FIGS. 1A-1C and 2, the C/O system 114 can determine roadway configurations based on various data. In some examples, the C/O system 114 is part of the barrier deployment system.

The reserved corridor can include one or more lanes of a roadway and is reserved for autonomous vehicles (e.g., self-driving cars, self-driving buses, self-driving trucks) and/or semi-autonomous vehicles (e.g., automated vehicles). The reserved corridor can be a space between a plurality of road barriers and an edge of the roadway, or can be a space between two sets of road barriers on each side of the reserved corridor. While the roadway is a general-purpose road available for all types of vehicles during specified periods of time, for other periods of time, a plurality of road barriers can be deployed on the roadway (e.g., as depicted in FIGS. 1A-1C and 2), dividing the roadway into multiple parts: the reserved corridor (i.e., the dedicated lanes for autonomous/semi-autonomous vehicles) and the general-purpose lanes. Among other benefits, the reserved corridor can improve safety, improve traffic throughput, reduce congestion, and improve connectivity of the autonomous vehicles or the semi-autonomous vehicles.

The barrier deployment system of the present disclosure enables safe and efficient deployment of the road barriers to create the reserved corridor with minimal disruption to traffic flow (e.g., preventing incidents and congestion). Here, the deployment of the road barriers can include physically moving the road barriers (e.g., sequentially or in parallel) to a location along the roadway and creating the reserved corridor for the autonomous vehicles or the semi-autonomous vehicles (e.g., as depicted in FIGS. 1A-1C). The deployment of the road barriers can be implemented in many different ways, such as using specialized road barrier moving trucks (e.g., a general purpose vehicle with an attachment that can move the road barriers, as depicted in FIGS. 1A-1C), a drone system to drop the barriers into place, an underground road barrier erecting system, a self-actuating barrier system, and the like. The barrier deployment system of the present disclosure can be applied to any type of road barrier deployment vehicles and/or devices.

In some examples, the barrier deployment system of the present disclosure can be realized using a computer system that includes one or more computers. The computer system can be implemented in an edge device located on the side of a roadway, can be located at a remote server system that communicates with a barrier deployment system (e.g., a vehicle that deploys the barriers) on a roadway, and/or can be located on the vehicle or device that deploys the road barriers. The computer system can implement a method for controlling and optimizing the deployment of the road barriers to create a reserved corridor.

In accordance with implementations of the present disclosure, the barrier deployment system obtains sensor data captured by one or more sensors installed on a roadway (e.g., through the IRB system 100, which can be include as part of the barrier deployment system). A variety of sensors can be located proximate to the roadway to generate sensor data regarding a road state of the roadway. The set of sensors can include, for example and without limitation, a microphone which senses pressure waves, a camera sensor which senses visual light, a hyper-spectrum camera sensor which senses light that is beyond visual light spectrum, a lidar sensor, a radar sensor, and so on.

The sensors can be a part of the computer system that controls and optimizes the deployment of the road barriers, and in this case, the system can directly obtain the sensor data. In some implementations, the sensors may not be part of the computer system, and the system can obtain the sensor data through a wired or wireless communication (e.g., Bluetooth, near-field communication, fiber, Wi-Fi, and so on). For example, the sensors can periodically send the sensor data to the barrier deployment system. As another example, the barrier deployment system can send a request to the sensors to get an update of the road state, and in response, the sensors can send the sensor data to the system.

In some implementations, the barrier deployment system determines the road state of the roadway by processing the sensor data. The road state of the roadway can include data of the traffic on the roadway. For example, the road state can include the speed of the traffic for each lane of the roadway, (e.g., 300 cars per hour on lane 1, and 290 cars per hour on lane 2). In some implementations, the road state can further include a status of each individual vehicle on the roadway.

The barrier deployment system determines, based on the road state, a predicted period of time to deploy the plurality of road barriers on the roadway. The barrier deployment system can determine a period of time to deploy the road barriers on the roadway, such that the road barriers can create a reserved corridor. In particular, the barrier deployment system can determine a period of time to deploy the road barriers safely and efficiently with minimum interruption to the traffic. In some implementations, the system can determine, based on the road state, a period of off-peak time (e.g., from 2:00 AM to 5:00 AM) when the road has less traffic such that deploying the road barriers can have less impact to the traffic.

In some implementations, it is desirable to have the reserved corridor during off-peak time when there is less traffic on the road. For example, autonomous trucks operating on the reserved corridor at night can have improved throughput, improved fuel efficiency, and improved safety (e.g., from reduced interruption from vehicles cutting in and out of lanes). The barrier deployment system can determine a predicted period of time to deploy the road barriers such that the reserved corridor can be created during off-peak time.

In some implementations, it is desirable to have a reserved corridor during peak time when there is heavy traffic on the road. For example, autonomous buses, autonomous personal cars can operate more smoothly and safely on the reserved corridor compared with operating on a general-purpose lane (e.g., with a mix of autonomous, semi-autonomous, and traditional vehicles). The barrier deployment system can determine a predicted period of time to deploy the road barriers such that the reserved corridor can be created before the roadway gets too busy.

The predicted period of time can be dynamically determined based on the current road state of the roadway and/or a predicted road state of the roadway. The road state of the roadway can include sub-states of one or more agents travelling on or within proximity of the roadway, sub-states of the road infrastructure, and sub-states of the environment, and so on.

In some implementations, the road state of the roadway can include data of the current traffic and/or the predicted traffic on the roadway. For example, the road state can include the speed of the traffic for each lane of the roadway, (e.g., 300 cars per hour on lane 1, and 290 cars per hour on lane 2). In some implementations, the road state can further include a status of each individual vehicle on the roadway.

The predicted period of time can be different on different days. Instead of using a fixed period of time (e.g., an off-peak period from 2:00 AM to 5:00 AM) every day, the deployment time of the road barriers can be dynamically determined based on the current road state of the roadway and/or a predicted road state of the roadway. For example, on a holiday or a weekend, the barrier deployment system can determine, from the road state, that the roadway has less traffic, and the system can determine that the off-peak period is from 1:00 AM to 6:00 AM. Therefore, the barrier deployment system can determine to deploy the road barriers earlier at 1:00 AM instead of 2:00 AM. As another example, on a particular day when an event is hosted near a roadway (e.g., a baseball game, or a concert), the system can determine, from the road state, that the roadway has more traffic, and the system can determine that the off-peak period is from 3:00 AM to 5:00 AM. Therefore, the system can determine to deploy the road barriers later at 3:00 AM instead of 2:00 AM.

In some implementations, the barrier deployment system can determine, based on the road state and additional information of the roadway, the predicted period of time to deploy the plurality of road barriers on the roadway. The additional information of the roadway can include information obtained from a traffic information database (e.g., through an application programming interface (API) of a map service database), sensor data from one or more vehicles travelling on the roadway, weather forecast information, and so on.

In some implementations, the barrier deployment system can maximize a period of time that the roadway has the reserved corridor for the autonomous vehicles or the semi-autonomous vehicles. The reserved corridor can improve safety, improve traffic throughput, reduce congestion, and improve connectivity of the autonomous vehicles or the semi-autonomous vehicles. Therefore, it is desirable to have the reserved corridor on the roadway for a long period of time. The barrier deployment system can determine an earliest possible time to deploy the road barriers in order to maximize the period of time that the roadway has the reserved corridor.

In some implementations, the barrier deployment system can predict the period of time to deploy the plurality of road barriers on the roadway based on the road state using a predetermined rule. The barrier deployment system can determine to start deploying the road barriers when a rate of traffic (e.g., speed of the traffic of a particular lane, or an average speed across multiple lanes) is below a threshold. For example, when an average rate of traffic across multiple lanes is less than 50 cars per hour, the barrier deployment system can determine to deploy the road barriers now because deploying the road barriers may have almost no impact to the traffic.

In some implementations, the barrier deployment system can predict the period of time to deploy the plurality of road barriers on the roadway based on the road state using a machine learning (ML) model. The ML model (e.g., a deep neural network model) can be trained using historical data, simulated data, and/or past experience of human drivers. In some examples, input to the ML model can be a road state, and the output of the ML model can be a predicted period of time to deploy the road barriers, a number of road barriers to deploy, type(s) of road barrier to deploy (e.g., physical, virtual), and the like. For example, the barrier deployment system can obtain simulated data of different road states with labels indicating a desired period of time to deploy the road barriers safely and efficiently. The labels can be obtained by human labelers and/or can be determined by computer simulations of deploying the road barriers. As another example, the barrier deployment system can obtain training data of previous road state with corresponding labels. The labels can include decisions made by a human driver (e.g., a driver who drives a road barrier deployment vehicle).

In some examples, the barrier deployment system can use the (trained) ML model to predict a period of time to deploy the road barriers and other characteristics as appropriate (e.g., a number of road barriers to deploy, type(s) of road barrier to deploy (e.g., physical, virtual)). For example, data representative of a road state, and any other appropriate data, can be provided as input to the ML model. The ML model outputs one or more periods of time to deploy the road barriers.

In some implementations, the barrier deployment system can determine, based on the road state, a predicted period of time to remove the plurality of road barriers on the roadway. The barrier deployment system can then remove the plurality of road barriers at an end time of the predicted period of time such that the reserved corridor. For example, based on the current road state of the roadway and/or a predicted road state of the roadway, the barrier deployment system can determine a predicted period of time when the roadway has less traffic, and therefore, removing the road barriers during the predicted period of time would have less impact to the traffic. For example, the barrier deployment system can determine, based on a predicted road state of the roadway, that the roadway has less traffic between 1:00 AM to 5:00 AM. The barrier deployment system can remove the road barriers at the end time of the period (e.g., at 5:00 AM). After removing the road barriers, the roadway does not include the reserved corridor. For example, the roadway can return to being a general-purpose road available for all types of vehicles. The techniques described in this disclosure regarding deploying the plurality of road barriers can be applied and adapted to removing the plurality of road barriers.

In some implementations, the road state can be a road state at a first time point, and the system can determine based on the road state at the first time point, a second time point to deploy the plurality of road barriers, wherein the second time point is at a later time point than the first time point. The second time point can be immediately after the first time point. For example, after receiving road state at a time point T, the system can determine whether to deploy the road barriers at a time point that is 10 minutes after T. Therefore, the system can dynamically determine the deployment time based on real-time or near real-time observation of the road state.

The barrier deployment system deploys the plurality of road barriers at a start time of the predicted period of time such that the plurality of road barriers create a reserved corridor. After determining the period of time, the barrier deployment system can determine a start time based on the predicted period of time. The barrier deployment system can determine that the start time is the beginning of the period of time. For example, if the barrier deployment system determines that the off-peak time of the roadway is 2:00 AM to 5:00 AM, the barrier deployment system can determine the start time can be 2:00 AM and the system can start the deployment of the road barriers at 2:00 AM.

In some implementations, deploying the plurality of road barriers can be performed by a vehicle that travels on the roadway. In some implementations, the vehicle that travels on the roadway can be an autonomous vehicle that has been configured to deploy the plurality of road barriers. The barrier deployment system can send a signal to the vehicle, and the signal can be based on the predicted period of time to deploy the plurality of road barriers on the roadway. The vehicle can deploy the plurality of road barriers on the roadway at a time that is based on at least the signal.

For example, a specialized designed vehicle can perform the deployment of the road barriers. The vehicle can receive a signal that includes the predicted period of time to deploy the road barriers. The vehicle can determine an actual start time of the deployment of the road barriers based on at least the received signal. In some implementations, the vehicle can determine the actual start time of the deployment of the road barriers based on additional information obtained by the vehicle (e.g., sensor data obtained by the sensors of the vehicle, the status of the vehicle). In some implementations, a human driver of the vehicle can determine the actual start time of the deployment based on the received signal.

In some implementations, the barrier deployment system can determine a period of time to remove the plurality of barriers. The barrier deployment system can determine, based on the road state, a predicted period of time to remove a plurality of road barriers on the roadway safely and efficiently with minimum interruption to the traffic. The barrier deployment system can remove the plurality of road barriers at a start time of the predicted period of time to remove the plurality of road barriers, such that the plurality of road barriers do not create a reserved corridor for autonomous vehicles. For example, after removing the plurality of road barriers, the entire roadway can operate as a general-purpose roadway available for all types of vehicles.

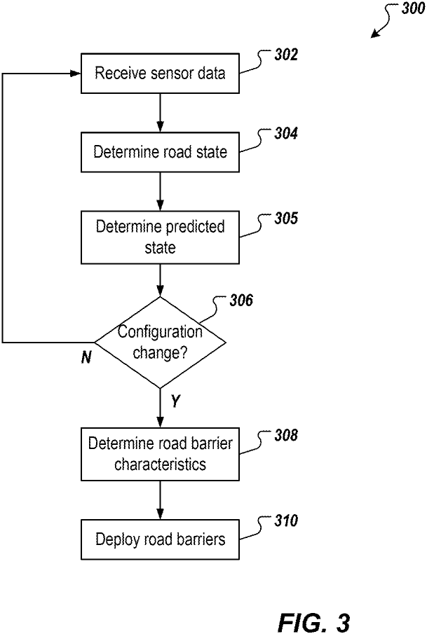

FIG. 3 depicts an example process 300 that can be executed in accordance with implementations of the present disclosure. In some examples, the example process 300 is provided using one or more computer-executable programs executed by one or more computing devices.

Sensor data is received (302). For example, and as described herein, at least one of the IRB kits and/or the C/O system receives sensor data. A road state is determined (304). For example, and as described herein, the at least one of the other IRB kits and/or the C/O system processes the sensor data to determine the road state of the roadway. In some examples, the road state data can indicate a configuration of the roadway, which can include one or more general-purpose lanes and one or more dedicated lanes. A predicted road state is determined (305). For example, a predicted road state can be provided as output of a ML model. In some examples, the predicted road state that is determined can include an expected configuration of the roadway for a period of time, such as an upcoming period of time. In some examples, the predicted road state can be determined from a plurality of predicted road states as achieving a highest level of improvement. For example, simulations can be executed to determine an optimal deployment configuration based on predicted road states, and a predicted road state can be selected as the most optimum.

It is determined whether there is a configuration change (306). For example, the expected configuration (e.g., of the predicted road state) can be compared to a current configuration that the roadway is operated with. In some examples, a set of parameters of the expected configuration can be compared with a set of parameters of the current configuration to determine whether there is a configuration change. In some examples, whether a configuration change is to occur can be determined based on whether there is one or more improvements to the road state, if changing to the predicted road state. For example, if traffic throughout is expected to increase by a predetermined threshold, an improvement would be achieved, and a configuration change is performed. If there is not a configuration change, the example process 300 loops back.

If there is a configuration change, road barrier characteristics are determined (308). For example, types of road barriers (e.g., physical, virtual) to add/remove are determined, locations of road barriers to add/remove are determined, means for adding/removing road barriers are determined (e.g., raising/lowering barriers, placing/removing barriers by vehicle/drone). Road barriers are deployed (310). For example, barriers are added/removed to meet the expected configuration as changed from the current configuration.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium) for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code) that constitutes processor firmware, a protocol stack, a database management system, an operating system, or a combination of one or more of them. A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display), LED (light-emitting diode) monitor, for displaying information to the user and a keyboard and a pointing device (e.g., a mouse or a trackball), by which the user may provide input to the computer. Other kinds of devices may be used to provide for interaction with a user as well; for example, feedback provided to the user may be any appropriate form of sensory feedback (e.g., visual feedback, auditory feedback, or tactile feedback); and input from the user may be received in any appropriate form, including acoustic, speech, or tactile input.

Implementations may be realized in a computing system that includes a back end component (e.g., as a data server), or that includes a middleware component (e.g., an application server), or that includes a front end component (e.g., a client computer having a graphical user interface or a Web browser through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”) (e.g., the Internet).

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are described in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the to be filed claims.

What is claimed is:

1. A computer-implemented method for selectively deploying barriers to adjust configurations of roadways, the method comprising:
obtaining sensor data captured by one or more sensors that generate data representative of characteristics of a roadway;
determining a state of the roadway by processing the sensor data, the state at least partially comprising a first configuration of the roadway;
determining, at least partially based on the state, a period of time to deploy a plurality of road barriers on the roadway; and
deploying the plurality of road barriers based on the period of time to provide a second configuration comprising at least one dedicated lane.

2. The method of claim 1, wherein determining, at least partially based on the state, the period of time to deploy the plurality of road barriers on the roadway comprises determining the period of time to deploy the plurality of road barriers on the roadway using a predetermined rule.

3. The method of claim 1, wherein determining, at least partially based on the road state, the period of time to deploy the plurality of road barriers on the roadway comprises predicting the period of time to deploy the plurality of road barriers on the roadway using a machine learning model.

4. The method of claim 1, wherein the state is at least partially generated from the sensor data captured by the one or more sensors at a first time point, wherein determining the period of time to deploy the plurality of road barriers on the roadway comprises:
determining, based on the state at the first time point, a second time point to deploy the plurality of road barriers, wherein the second time point is at a later time point than the first time point.

5. The method of claim 1, wherein deploying the plurality of road barriers is performed by a vehicle that travels on the roadway, and the method further comprises:
sending a signal to the vehicle, wherein the signal is based on the period of time to deploy the plurality of road barriers on the roadway; and
deploying, by the vehicle, the plurality of road barriers on the roadway at a time that is based on at least the signal.

6. The method of claim 1, wherein determining, at least partially based on the state, the period of time to deploy the plurality of road barriers on the roadway comprises maximizing a period of time that the roadway has the at least one dedicated lane.

7. The method of claim 1, wherein the at least one dedicated lane is for one or more autonomous vehicles and semi-autonomous vehicles.

8. The method of claim 1, wherein the first roadway configuration is absent any dedicated lanes.

9. The method of claim 1, wherein the plurality of road barriers comprises virtual barriers and deploying the plurality of road barriers at least partially comprises:
sending data indicating the virtual barriers to vehicles on the roadway for period of time, wherein after receiving the data indicating the virtual barriers, the vehicles are instructed to not cross the virtual barriers.

10. The method of claim 1, further comprising:
determining, based on the state, a period of time to remove the plurality of road barriers on the roadway; and
removing the plurality of road barriers for the period of time to provide a third configuration.

11. The method of claim 10, wherein the second roadway configuration includes the at least one dedicated lane having a first length and the third configuration includes the at least one dedicated lane having a second length that is different from the first length.

12. The method of claim 10, wherein the second roadway configuration includes the at least one dedicated lane having a first location and the third configuration includes the at least one dedicated lane having a second location that is different from the first location.

13. A system comprising one or more computers and one or more storage devices storing instructions that when executed by the one or more computers cause the one or more computers to perform operations comprising:
obtaining sensor data captured by one or more sensors that generate data representative of characteristics of a roadway;
determining a state of the roadway by processing the sensor data, the state at least partially comprising a first configuration of the roadway;
determining, at least partially based on the state, a period of time to deploy a plurality of road barriers on the roadway; and
deploying the plurality of road barriers based on the period of time to provide a second roadway configuration comprising at least one dedicated lane.

14. One or more computer storage media storing instructions that when executed by one or more computers cause the one or more computers to perform operations comprising:
obtaining sensor data captured by one or more sensors that generate data representative of characteristics of a roadway;
determining a state of the roadway by processing the sensor data, the state at least partially comprising a first configuration of the roadway;
determining, at least partially based on the state, a period of time to deploy a plurality of road barriers on the roadway; and
deploying the plurality of road barriers based on the period of time to provide a second roadway configuration comprising at least one dedicated lane.
